(19) United States
(12) Patent Application Publication
(10) Pub. No.: US 2008/0305420 A1
(43) Pub. Date: Dec. 11, 2008

(54) METHOD AND DEVICE FOR COATING PARTICLES, AND CARRIER FOR USE IN DEVELOPER

(76) Inventors: Naotoshi KINOSHITA, Numazu-shi (JP); Tetsuya TANAKA, Sunto-gun (JP); Masahiro KAWAMOTO, Sunto-gun (JP); Hiroyuki INA, Sunto-gun (JP); Jun HITOSUGI, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/133,052

(22) Filed: Jun. 4, 2008

(30) Foreign Application Priority Data
Jun. 11, 2007 (JP) 2007-154399

(51) Int. Cl. B05D 7/00; B05B 7/24; G03G 13/06

(52) U.S. Cl. 430/97; 118/310; 427/212; 427/213; 239/403; 239/433; 430/118.5

(57) ABSTRACT

A method for coating particles with a coating liquid including supplying airflow to fluidize the particles; mixing the coating liquid with a spray gas in a two-fluid spray nozzle to form a two-phase flow; and atomizing the two-phase flow with the spray gas to spray a mist of the coating liquid upon the particles. A coating device including a vessel; a fluidizing device configured to supply airflow to fluidize a powder in the vessel; and a spray nozzle configured to mix the coating liquid with a spray gas to form a two-phase flow, and to atomize the two-phase flow with the spray gas to spray a mist of the coating liquid. A particulate carrier for use in electrophotographic developer including particles of a core material and a cover layer thereon and prepared by the coating method mentioned above.

### BACKGROUND OF THE INVENTION

1. Field of the Invention

The present invention relates to a granulating/coating method for coating particles with a coating liquid. In addition, the present invention also relates to a granulating/coating device for coating particles with a coating liquid, and to a particulate carrier for use in a developer, which is used for image forming methods such as electrophotography, electrostatic recording, and electrostatic printing.

2. Discussion of the Background

Conventional granulating/coating devices typically perform one or more of the following processes:
(1) A process of spraying various raw materials into a vessel to prepare a particulate material constituted of the raw materials;
(2) A process of coating particles (hereinafter sometimes referred to as a powder), which is contained in a vessel, with a coating liquid; and
(3) A process of adhering the coated particles prepared in (2) to prepare aggregates of the particles.

For example, it is well known to spray a coating liquid of a material to a powder contained in a vessel from a nozzle to wet the powder with the coating liquid while drying the coating liquid, resulting in formation of a particulate material, whose surface is coated with the material or formation of a granulated material. In general, an air supplying device is provided on a bottom portion of such granulating/coating devices to fluidize the powder contained in the vessel and the resultant particulate material while drying the coated liquid. By using such granulating/coating devices, a particulate material in which the thickness of the coated layer and the particle diameter of the resultant particulate material are controlled can be produced.

As one of such granulating/coating devices, published unexamined Japanese patent application No. (hereinafter referred to as JP-A) 2004-294690 discloses a device in which a coating liquid is sprayed to a fluidized layer of carrier particles.

The conventional granulating/coating devices mentioned above have the following drawbacks.

At first, the drawbacks common to such conventional granulating/coating devices will be explained.

In a spraying operation (granulating/coating operation) in which a coating liquid is sprayed to a powder using a liquid supplying device such as spray nozzles, a problem in that the particles of the coated powder aggregate and the aggregates are adhered to the inner wall of the coating devices is caused. When such aggregates are formed, not only the yield of the product deteriorates, but also a problem in that the next product (or next batch) is contaminated with the aggregates of the former products remaining in the device occurs.

For example, in a case where a core material of a carrier for use in electrophotographic developer is coated with a coating liquid, the aggregates of the core material remaining in the device while being adhered thereto include a large amount of core material particles whose surface is not coated or hardly coated with the coating liquid because the aggregates have a little chance of being contacted with the coating liquid after the aggregates are formed. Therefore, a large amount of carrier particles having a thin coat layer thereon are included in the resultant carrier. In this case, the durability of the carrier deteriorates, and thereby high quality images cannot be stably produced.

Specifically, the problems in that aggregates of particles of a powder coated with a coating liquid are formed, and the aggregates are adhered to the inside of the coating device are described in JP-As 05-216285, 06-138710 and 11-258857 (concerning granulating/coating devices, and carriers prepared thereby) and JP-A 05-192555 (i.e., Japanese patent No. 3329853, concerning a method for coating a particulate material). In attempting to solve the problems, these patent applications have made proposals such that functions such as treatment temperature, amount of air supplied, and rotation speed of the agitator for agitating a particulate material are properly controlled.

As a result of the present inventors' investigation, it is found that the main factor of formation of aggregates is the continuity and uniformity of the sprayed coating liquid, namely it is very important to spray a coating liquid continuously and uniformly not to form aggregates. Specifically, when the spray nozzle is clogged, the uniformity of the particle diameter of sprayed liquid particles (hereinafter sometimes referred to as the particle diameter of a mist), the angle and direction of the sprayed liquid particles change, and in addition the amount of the sprayed liquid particles change, namely, the continuity and uniformity of the sprayed coating liquid deteriorate. As a result, aggregates of the powder are formed and the aggregates are adhered to the coating device, and thereby the yield of the product is decreased.

The problems concerning spray nozzles will be explained.

In granulating/coating devices (particularly in fluidized bed type granulating/coating devices), the tips of spray nozzles are exposed to particles of a powder circulating in the fluidized bed, and thereby a problem in that the powder particles are adhered to the tips of the nozzles or enter into the nozzles, resulting in clogging of the nozzles with the powder particles is frequently caused. In addition, a problem in that the spray nozzles are clogged with dried materials of the coating liquid (e.g., precipitated materials of materials dissolved in the coating liquid, and aggregates of materials dispersed in the coating liquid), which are formed before the sprayed coating liquid is sprayed, can occur. Even when the coating liquid is not dried, a problem in that the spray nozzles are clogged with aggregates of the materials dispersed in the coating liquid can occur if the coating liquid is a slurry in which solid materials are dispersed. Nozzle clogging irreversibly proceeds as continuous or batch coating treatments are repeatedly performed. The nozzle clogging problem is seriously caused to the spray nozzles arranged at a location lower than a fluidized layer of the powder to be treated, in which the density of the powder is high, or the side spray nozzles arranged at a side portion of a fluidized powder layer, in which the density of the powder to be treated is high because the powder is circulated by a centrifugal force of an agitating operation for the fluidized layer. In addition, the nozzle clogging problem is seriously caused when the powder to be treated has a small particle diameter of not greater than 30 μm, and/or the powder has a high specific gravity like core materials of carriers for use in electrophotographic developers.

In general, when using a two-fluid type spray nozzle having a gas nozzle for discharging a spray gas and a fluid (liquid) nozzle for discharging a coating liquid, the gas nozzle is hardly clogged because a spray gas is discharged therethrough at a high pressure of from 0.1 to 0.6 MPa but the liquid nozzle can cause the nozzle clogging problem because the coating liquid is fed at a relatively low pressure. Specifically, when the liquid nozzle is clogged with, for example, aggregates of the dried materials of the coating liquid, the aggregates are hardly removed by the flown coating liquid. Therefore, it is necessary to stop the coating device in order to remove the aggregates from the nozzle (i.e., to recover the spray nozzle). Therefore, various methods for preventing occurrence of the nozzle clogging problem have been proposed.

In attempting to solve the nozzle clogging problem in that a material included in a coating liquid is gradually accumulated on a spray nozzle (gun), resulting in clogging of the spray gun, JP-A 2000-140709 discloses a coating device in which compressed air is intermittently supplied to the air nozzle thereof, and a coating device using a high-volume and low-pressure spray nozzle.

However, the coating device has a drawback in that when the amount of air used for spraying increases, the burden on the utility also increases. In addition, although this technique is useful for preventing clogging of the air nozzle, the technique hardly prevents occurrence of clogging of a liquid nozzle.

In addition, in attempting to solve the nozzle clogging problem, JP-A 2000-312817 discloses a granulating/coating device in which a needle capable of changing its position is provided in a liquid nozzle to remove dried materials adhered to the exit of the liquid nozzle. However, this technique has a drawback in that a sealing member for preventing leaking of the coating liquid from the liquid nozzle has to be provided as well as the needle, namely, the nozzle has a complex structure. This technique is a problem remedying technique (i.e., a technique as to how the clogged nozzle is recovered) and is not a fundamental solution. Further, when the needle is operated, the flow of the coating liquid is changed, and thereby the nozzle clogging problem may be caused due to the change of the flow of the coating liquid depending on the properties of the coating liquid used.

Further, JP-A 2003-001090 discloses a fluidized bed coating device in which the method for supplying a spray gas to a two-fluid type spray nozzle is improved, in order to well coat a coating liquid. In this coating device, the spray nozzle supplies a swirling spray gas to form uniform mists of the coating liquid, in attempting to produce a product having uniform properties and a sharp particle diameter distribution with a high yield. It is described in JP-A 2003-001090 that the spray nozzle used therein has the similar structure as that described in JP-A 2000-254554.

JP-A 2003-280291 discloses a coating device, which is used for coating a core material of a carrier for use in electrophotography. Specifically, in the coating device, spray coating is performed on a core material of a carrier, which is fluidized by being centrifugally rolled on a rotated slanting disc, in attempting to enhance the yield of the product (i.e., carrier).

However, as a result of the present inventors' experiments, it is found that the coating devices disclosed in JP-As 2003-001090, 2000-254554 and 2003-280291 cannot solve the problems concerning clogging of spray nozzles and supply of a coating liquid.

In addition, JP-As 02-90957 and 04-145937 have disclosed coating devices. The spray nozzle of the coating device described in JP-A 02-90957 has a structure such that a first air discharging passage is provided outside a liquid discharging passage, and a second air discharging passage is provided outside the first air discharging passage. It is described therein that by using this spray nozzle for granulating/coating devices, particles of a powder to be coated are activated near the spray nozzle, and thereby formation of coarse particles and agglomeration of coated particles can be prevented.

In the coating device of JP-A 04-145937, unlike the coating device of JP-A 02-90957, a secondary airflow is formed around a spray nozzle to decrease the density of particles of the powder to be treated, in attempting to prevent formation of coarse particles. Although it may be possible that occurrence of the problems such as formation of coarse particles and agglomeration of coated particles in the spraying zone are prevented by this coating device, occurrence of the problems in that particles are adhered to the spray nozzle itself, clogging of the nozzle with the particles adhered thereto, and clogging of the nozzle caused when a coating liquid having a high viscosity is used cannot be prevented. Further, it is necessary for the coating device to supply compressed air in a larger amount than those in conventional coating devices using a spray nozzle, resulting in increase of the running costs. In addition, proper manufacturing conditions such as ratio of primary airflow to secondary airflow are not disclosed therein. Therefore, the technique is incomplete and should be further improved.

Thus, spray nozzles are important elements for granulating/coating devices. However, the nozzle clogging problem has not yet been solved, and a fundamental solution is not yet proposed. As mentioned above, the nozzle clogging problem causes big losses with respect to properties of the product and costs. Specifically, when the nozzle clogging problem is caused, the coating operation has to be stopped or the properties of the product deteriorate due to aggregates of the coated particles, resulting in occurrence of a problem in that the lot of the product cannot be used. If a maintenance operation is periodically performed to avoid the nozzle clogging problem, another problems in that the manufacturing costs of the product increase and the amount of the product decreases occur.

JP-A 05-309314 discloses a spray coating method, which is used for another technical field, i.e., for spray-coating a fluidized particulate material with a melted wax (which is used instead of a wax dissolved in an organic solvent. Specifically, the spray nozzle has a two-fluid nozzle. From one of the nozzles, a melted wax is discharged after mixed with a heated gas in the passage of the spray nozzle, and from the other nozzle, a heated gas is discharged. The nozzles have diameters of from 1.5 to 5.8 mm, and have no needle valve. It is described therein that by using this spray nozzle, occurrence of the problems such as clogging of the nozzle with the cooled wax (caused by spraying) and formation of a powdered wax and aggregates of the powdered wax can be prevented.

As described in JP-A 2003-280291, a need exists for a low-cost carrier which can be used for a developer for electrophotography capable of producing high quality images. Therefore, it is very important to solve the nozzle clogging problem.

Because of these reasons, a need exists for a granulating/coating device which can stably spray a coating liquid without causing the nozzle clogging problem and which can produce a product (such as carriers) having a uniform coated layer and uniform properties at a high efficiency without forming aggregates of coated particles.

### SUMMARY OF THE INVENTION

As an aspect of the present invention, a method for coating particles (a powder) with a coating liquid (such as solvents, solutions and slurries) is provided which includes:

supplying airflow to the powder in a vessel to fluidize the powder;

mixing the coating liquid with a spray gas in a passage in a two-fluid spray nozzle to form a two-phase flow (i.e., the mixture of the coating liquid and the spray gas), which is accelerated by the spray gas; and

atomizing the two-phase flow with the spray gas to spray a mist of the coating liquid upon the fluidized particles.

As another aspect of the present invention, a coating device for coating particles (a powder) with a coating liquid is provided which includes:

a vessel;

a fluidizing device configured to supply airflow to the powder in the vessel to fluidize the particles; and

a spray nozzle configured to mix the coating liquid with a spray gas to form a two-phase flow, and to atomize the two-phase flow with the spray gas to spray a mist of the coating liquid upon the fluidized particles.

As yet another aspect of the present invention, a particulate carrier (such as carriers for use in developers for electrophotography, etc.) is provided, which includes particles of a core material and a layer located on the surface of the particles of the core material and which is prepared by the coating method mentioned above.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating a spray nozzle for use in the granulating/coating device of the present invention;

FIG. 2 is a schematic view illustrating another spray nozzle for use in the granulating/coating device of the present invention;

FIG. 3 is a schematic view illustrating an example of the granulating/coating device of the present invention;

FIG. 4 is a schematic view illustrating yet another spray nozzle for use in the granulating/coating device of the present invention;

FIG. 5 is a schematic view illustrating another example of the granulating/coating device of the present invention;

FIG. 6 is a schematic view illustrating a spray nozzle used for conventional granulating/coating devices;

FIG. 7 is a schematic view illustrating yet another example of the granulating/coating device of the present invention;

FIG. 8 is a schematic view illustrating another spray nozzle used for conventional granulating/coating devices;

FIG. 9 is a schematic view illustrating a torquing member to be provided in the spray nozzle of the granulating/coating device of the present invention;

FIG. 10 is a schematic view illustrating the torquing member provided in the spray nozzle illustrated in FIG. 4;

FIG. 11 is a schematic view for explaining the length L of the passage needed for forming a two-phase flow in the spray nozzle; and

FIG. 12 is a schematic view illustrating a part of a spray nozzle in which a spray gas is eccentrically supplied to a spray liquid passage to form a two-phase flow.

### DETAILED DESCRIPTION OF THE INVENTION

The granulating/coating method of the present invention applies not only to coated carriers for use in electrophotography, but also to foods such as fragrant materials, saccharide, amino acids, proteins, wheat, food dyes, and starch; chemicals such as drugs (e.g., general drugs (e.g., ethoxybenzamide, acetaminophen, and caffeine), antibacterial agents, and Chinese herbal medicines)), particulate resins, particulate inorganic materials (e.g., particulate metals, metal oxides and carbon blacks), fine ceramics, salts, pigments, dyes, powdery surfactants for use in detergents, and other chemicals; etc.

Hereinafter, the granulating/coating method (hereinafter referred to simply as the coating method) of the present invention will be explained in detail.

Specific examples of the coating liquid (hereinafter sometimes referred to as the spray liquid) to be discharged from the spray nozzle of the granulating/coating device (hereinafter referred to as the coating device) of the present invention include solvents such as water and organic solvents, and solutions, dispersions and slurries in which a material is dissolved or dispersed in a solvent (such as water and organic solvents), etc.

In the coating method and device of the present invention, a coating liquid is mixed with a part of a spray gas to form a two-phase flow (i.e., a gas-liquid mixture) and then the flow velocity of the two-phase flow is accelerated. In addition, the two-phase flow and the spray gas are collided with each other (i.e., the residue of the spray gas is sprayed upon the two-phase flow) to form and discharge a mist of the two-phase flow. In this regard, the mist is defined as fogged materials of liquid droplets.

Air is typically used as the spray gas, but other gasses such as inert gasses (e.g., steam and nitrogen gas) can also be used depending on the properties of the coating liquid.

Since the coating liquid is previously mixed with a spray gas to form a two-phase flow, the coating liquid is well dispersed to an extent before being discharged from the spray nozzle. Thereby, serious wetting of the nozzle and the vicinity thereof with the coating liquid (i.e., local wetting of the nozzle and the vicinity thereof) can be avoided, resulting in prevention of the treated powder from adhering to the nozzle. In addition, since a two-phase flow is formed, the volume of the fluid (i.e., two-phase flow) is increased, thereby increasing the flow speed of the fluid. Thereby, occurrence of the problems in that the dried materials of the coating liquid or the materials precipitated in the coating liquid are adhered to the nozzle or the nozzle is clogged with such dried or precipitated materials can be prevented.

In addition, since a spray gas is collided to the coating liquid, the coating liquid can be granulated relatively finely compared to the cases where the collision of a spray gas with the coating liquid is not performed.

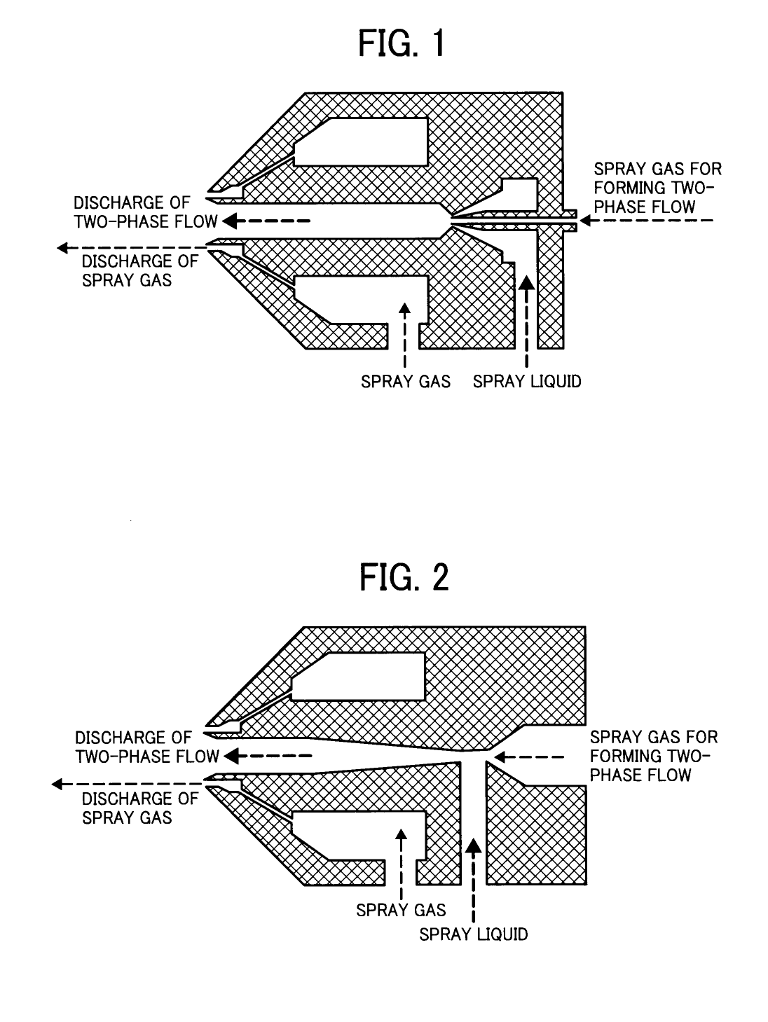

In this regard, the spray gas used for spraying the coating liquid (i.e., the spray gas discharged from a nozzle near a main nozzle in FIG. 1, hereinafter sometimes referred to as the primary spray gas) is also used for forming the two-phase flow. Therefore, it is not necessary to use a different kind of spray gas for forming the two-phase flow. Since the spray gas used for forming and accelerating the two-phase flow contributes to formation of a mist, it is not necessary to increase the total amount of the spray gas (i.e., the total amount of the primary spray gas and the spray gas mixed with the coating liquid).

The spray nozzle for use in the coating device of the present invention, for example, has a structure illustrated in FIG. 1, 2 or 4.

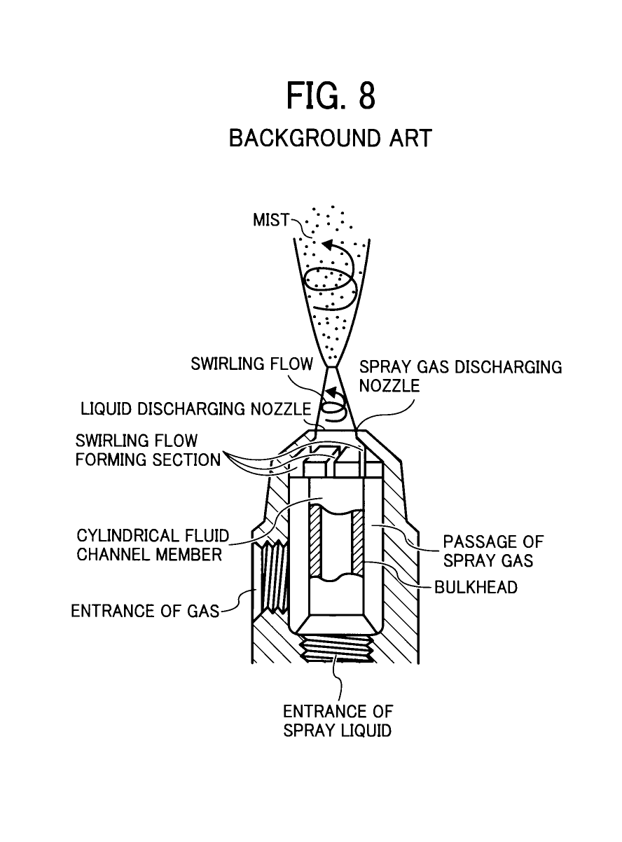

A background spray nozzle illustrated in FIG. 8 does not have a function of feeding a coating liquid. Therefore, the spray nozzle tends to cause the nozzle clogging problem in that an inside portion of the nozzle is clogged with dried or precipitated materials relatively easily compared to the spray nozzle for use in the present invention.

In the background spray nozzle illustrated in FIG. 8, the coating liquid is mixed with a spray gas in the main body of the spray nozzle (i.e., the spray nozzle is an internal mixing spray nozzle). Namely, a gas flow is not formed at the tip of the nozzle. When the nozzle is used for a coating device, the concentration of the powder to be treated at the tip of the nozzle is high. Therefore, the tip of the nozzle, which is wet with the coating liquid, tends to be easily contacted with the particles of the powder, resulting in occurrence of the problem in that the tip of the nozzle is clogged with the particles of the powder.

In the above-mentioned nozzles disclosed in JP-A 02-90957 and 05-309314, at first a coating liquid is finely granulated by a first gas flow, and the granulated coating liquid is then contacted with a second gas flow. In contrast, in the spray nozzle for use in the present invention, a coating liquid is previously mixed with a spray gas in a passage (i.e., flow channel) in the spray nozzle to form a two-phase flow before the coating liquid is sprayed. Therefore, the nozzles disclosed in JP-A 02-90957 and 05-309314 are clearly different from the spray nozzle for use in the present invention.

The volume ratio of the spray gas used for forming a two-phase flow to the spray gas (primary spray gas) used for forming a mist of the two-phase flow is generally from 5/95 to 40/60, preferably from 10/90 to 30/70, and more preferably from 10/90 to 20/80.

When the amount of the spray gas for forming a two-phase flow is too small, a uniform two-phase flow cannot be formed. In addition, the effect of accelerating the flow velocity of the two-phase flow is little, and thereby a good effect of preventing the nozzle clogging problem can be hardly produced and in addition the coating liquid cannot be finely granulated. In contrast, when the amount of the spray gas for forming a two-phase flow is too large (i.e., the amount of the primary spray gas is small), the coating liquid is granulated relatively finely compared to the case where the amount of the spray gas for forming a two-phase flow is small. In this case, since the amount of the primary spray gas is small, the primary spray gas can hardly granulate the relatively finely granulated coating liquid because of having a small dispersing energy. As a result, the granulating performance in this case is inferior to that in the case where the volume ratio of the spray gas to the primary spray gas falls in the above-mentioned range. In other words, the spray gas can hardly contribute to formation of a mist of the coating liquid. Therefore, it is not preferable. In addition, when the amount of the primary spray gas is small, the tip of the nozzle tends to be easily contacted with the powder to be treated, thereby easily causing the problems in that the powder is adhered to the nozzle and the nozzle is clogged with the powder.

In the spray nozzle for use in the coating device of the present invention, it is preferable that a coating liquid is discharged from one main nozzle in an amount of from 3 to 200 ml/min, and a spray gas (i.e., a primary spray gas) is discharged from one nozzle in an amount of from 10 to 1000 liter/min.

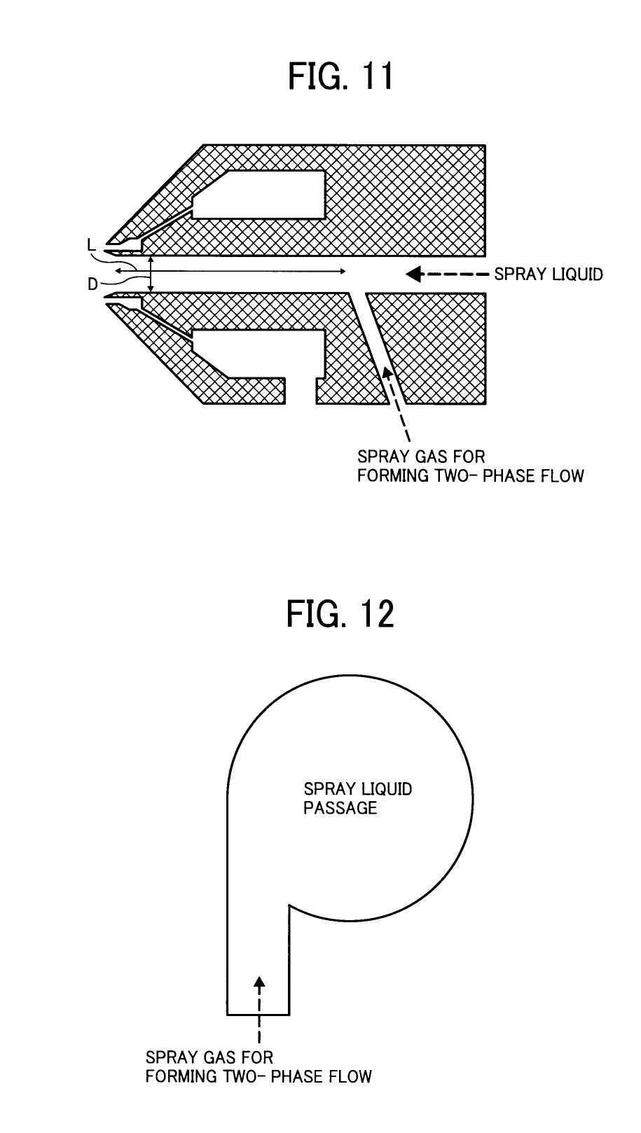

In addition, the passage for forming a two-phase flow preferably has a length (L) of not less than four times the circle-equivalent diameter (D) of the opening of the nozzle, from which the two-phase flow is discharged, as illustrated in FIG. 11. In this case, the two-phase flow is stably discharged from the nozzle, and thereby the primary spray gas can be stably collided with the two-phase flow. Therefore, the coating liquid can stably achieve a mist state. When the length L is too short, an unstable two-phase flow is discharged from the nozzle, and thereby the coating liquid cannot stably achieve a mist state. Namely, gas-liquid mixing is not well performed, and thereby the particle diameters of the liquid droplets and bubbles of the spray gas cannot be sufficiently decreased (i.e., the particle diameters are relatively large compared to the desired particle diameters). In other words, the two-phase flow is discharged from the nozzle before dispersion and fracturing of spray liquid droplets and spray gas bubbles are not sufficiently performed. When passage for forming a two-phase flow preferably has a length (L) of not less than four times the circle-equivalent diameter (D) of the opening of the nozzle, the liquid droplets and spray gas bubbles in the two-phase flow can have sharp particle diameter distributions.

In this regard, the circle-equivalent diameter d is defined by the following equation:

d=(4S/π)^{1/2} (i.e., S=(π×d²)/4)

wherein S represents the cross-section area of the passage (i.e., the area of the opening).

The amount of the primary spray gas for forming a mist of a two-phase liquid will be explained. In a case where air is used as the spray gas and water is used as a coating liquid, the liquid-gas (water-air) ratio B/A of the amount (B) of sprayed water in units of milliliter per minute to the amount (A) of supplied air in units of normal litter (NL) per minute is generally from 0.1 to 3, preferably from 0.1 to 2, and more preferably from 0.15 to 1.5.

When a spray gas α and a coating liquid β are used, the following relationships are preferably satisfied:

0.1≦(Yx(y/b))/(Xx(x/a)≦3;

preferably, 0.1≦(Yx(y/b))/(Xx(x/a)≦2; and

more preferably, 0.15≦(Yx(y/b))/(Xx(x/a)≦1.5,

wherein X represents the amount (NL/min) of the supplied spray gas α, x represents the specific gravity of the spray gas α, Y represents the amount (ml/min) of the sprayed coating liquid β, y represents the specific gravity of the coating liquid β, and a and b represent the specific gravities of air and water, respectively.

In this regard, the amount X of the spray gas is defined as the total amount of the spray gas used as the primary spray gas for forming a mist of the coating liquid and the spray gas used for forming a two-phase flow.

Namely, by properly controlling the mass flow rate of the coating liquid and the spray gas so as to fall in the above-mentioned range, a good spraying operation can be performed.

It is clear from the relationship that when a nitrogen gas is used as the spray gas, the amount (NL/min) of the nitrogen gas should be larger than in the case where air is used as the spray gas. In addition, when a coating liquid having a relatively large specific gravity is used, it is preferable to increase the amount of the supplied spray gas.

When the liquid-gas ratio is too large, the coating liquid cannot be well granulated, resulting in poor granulating and coating performances. In contrast, when the liquid-gas ratio is too small, the granulating performances (such as the degree of decrease in the particle diameter of the droplets of the coating liquid, and the degree of improvement in sharpness of the particle diameter distribution of the droplets) cannot be further improved compared to a case where the liquid-gas ratio falls in the proper range. Therefore, it is not preferable because of being waste of energy.

The primary pressure of the spray gas used is determined such that the above-mentioned amount of the spray gas is satisfied. In general, the primary pressure of the spray gas is from 0.1 to 0.7 MPa. Spray gasses having such a pressure can be easily obtained industrially. When the primary pressure is too low, the coating liquid cannot be well dispersed. In contrast, when the primary pressure is too high, it is necessary to improve the pressure resistance of members for feeding the spray gas (such as tubes and feeding devices). However, spray gasses having such a primary pressure have a dispersing ability not worse than that in cases where the primary pressure is lower than the primary pressure.

In order to form a two-phase flow, ejectors, venturi tubes and ring nozzles can be preferably used for the spray nozzle. An example of ejectors (hereinafter referred to as spray nozzles having ejector structure), which can be preferably used for the coating device of the present invention, is illustrated in FIG. 1, and an example of venturi tubes (hereinafter referred to as spray nozzles having a venturi structure) is illustrated in FIG. 2. By using spray nozzles having ejector structure, venturi structure or ring nozzle structure, a well-dispersed two-phase flow can be efficiently prepared while preventing a problem of back-flow of the coating liquid through the feeding tube.

When spraying is performed while forming a two-phase flow, internal mixing type two-phase flow spray nozzles are used. In this case, a back flow problem in that the coating liquid is flown back into the tube supplying the coating liquid can occur when the pressure for supplying the liquid is much lower than the pressure of the spray gas. By using spray nozzles having ejector structure, venturi structure or ring nozzle structure, the coating liquid can be fed toward the exit of the spray nozzle without causing the back flow problem even when the pressure for supplying the coating liquid is lower than that of the spray gas.

As mentioned above, a spray nozzle having ejector structure for use in the coating device of the present invention is illustrated in FIG. 1, and a spray nozzle having venturi structure for use in the coating device of the present invention is illustrated in FIG. 2. A spray nozzle having ring nozzle structure is not shown, but has such a structure that the passage for feeding the spray gas and the passage for feeding the coating liquid in FIG. 1 are exchanged. The method for preventing occurrence of the back flow problem is not limited to the methods using a spring nozzle having ejector structure, venturi structure or ring nozzle structure, and any other methods by which a two-phase flow can be formed while applying a driving force to the coating liquid can be used.

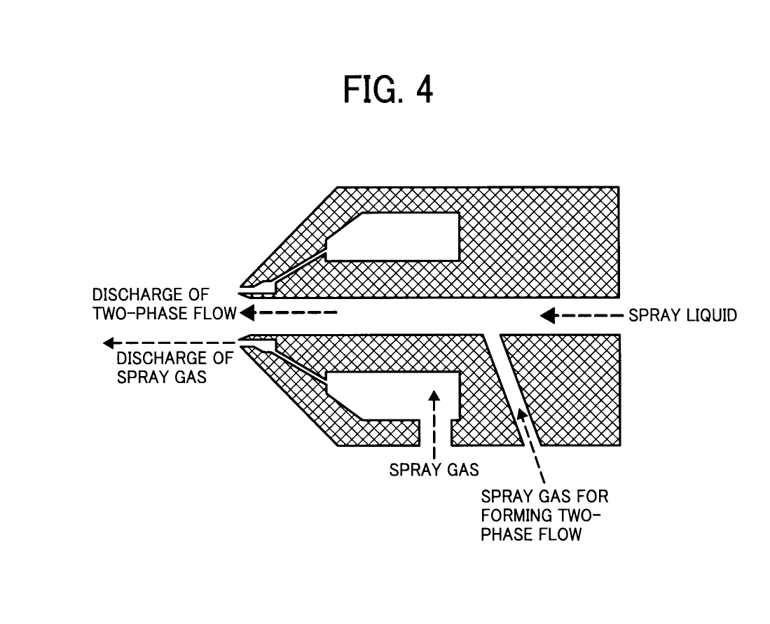

The two-phase flow may be a swirling flow. Such a swirling two-phase flow can be formed by a nozzle illustrated in FIG. 12. For example, when the mixing portion of the spray nozzle illustrated in FIG. 4, at which the spray gas is mixed with the coating liquid, has across-section (i.e., an eccentric structure) as illustrated in FIG. 12 (the cut surface of this cross section is perpendicular to the that of the cross section illustrated in FIG. 4), a swirling two-phase flow can be formed. Specifically, by feeding a spray gas along the wall of the spray liquid passage (i.e., coating liquid passage) as illustrated in FIG. 12, a swirling two-phase flow can be formed. By forming a swirling two-phase flow, problems in that solid components and dried materials of the coating liquid are adhered to or precipitated on the wall of the coating liquid passage can be avoided, resulting in prevention of occurrence of the nozzle clogging problem.

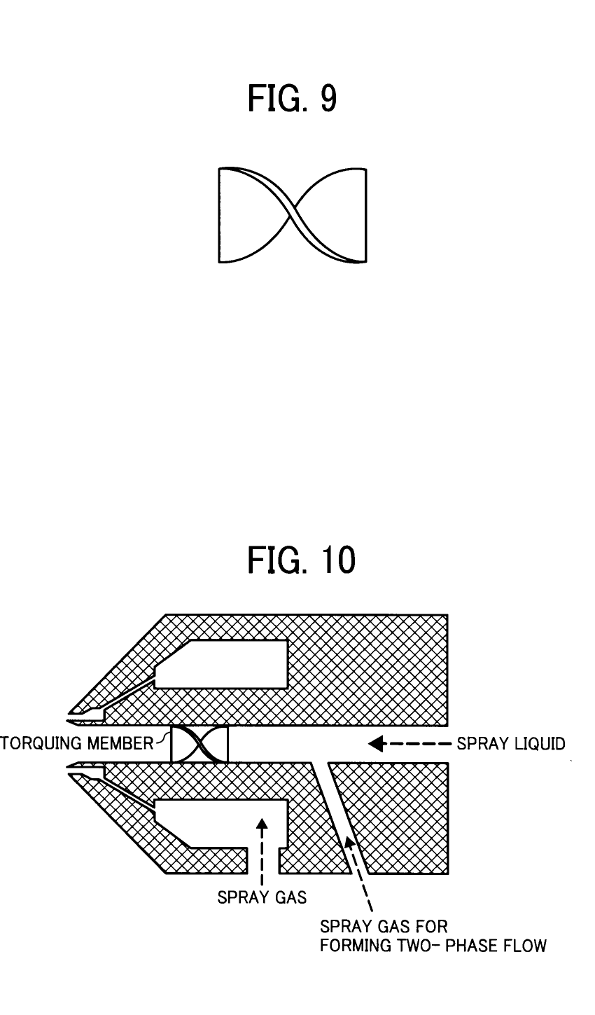

Another method for forming a swirling two-phase flow is to provide a torquing member at a location of the coating liquid passage, in which a two-phase flow is flown. Suitable torquing members include baffle plates which can change the direction of a two-phase flow, spiral grooves formed on the coating liquid passage, etc. Specific examples of the torquing member include a member as illustrated in FIG. 9, which has a structure similar to that of a mixing element used for static mixers. FIG. 10 illustrates an example spray nozzle capable of forming a swirling two-phase flow, in which the torquing member illustrated in FIG. 9 is set in the coating liquid passage of the spray nozzle illustrated in FIG. 4.

The coating device of the present invention includes a mixing/fluidizing device (hereinafter referred to as a fluidizing device) for colliding airflow against the powder to be treated to fluidize the powder. Suitable fluidizing devices include mixing devices, which can supply an airflow (such as high speed mixers from Fukae Powtec Co., Ltd.), fluidized bed devices (such as FLOW COATER from Okawara Mfg. Co., Ltd., SPIRA COTA from Okada Seiko Co., Ltd. and MULTIPLEX from Powrex Corporation). Among these fluidizing device, the fluidized bed devices can be preferably used. An examples of such fluidized bed devices is illustrated in FIG. 1 of JP-A 07-265683 mentioned above.

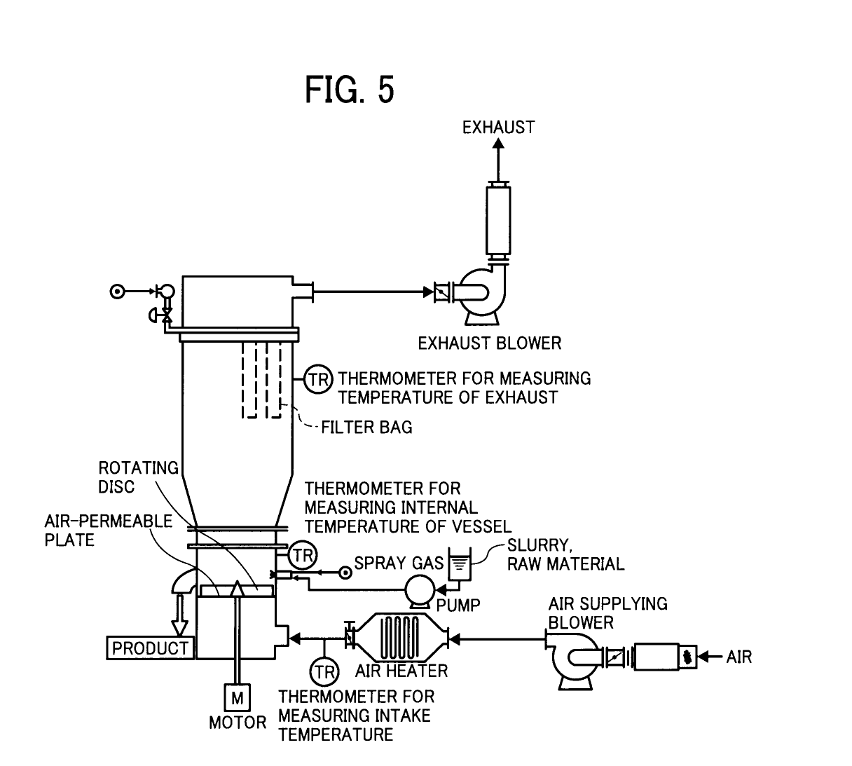

The fluidized bed granulating/coating method using a fluidized bed and the devices using the method will be explained by reference to FIGS. 5 and 7.

The coating device illustrated in FIG. 5 includes a vessel having a bulkhead capable of holding a layer of a powder (such as air-permeable plates, distributors and catching plates) on a bottom thereof; an air supplying blower (i.e., a fluidizing device) for supplying air (spray gas) to the vessel through the bulkhead (air permeable plate) to fluidize the powder; a spray nozzle for spraying a coating liquid (such as binder resin solutions) to the fluidized powder in the vessel; a collector (such as filter bags and cyclones) which is provided at the air exit of the vessel and which prevents the powder from being discharged from the vessel; an agitator (such as agitating blades and rotating discs) for agitating, mixing and rolling the powder in the vessel; etc.

Another coating device illustrated in FIG. 7 includes a cylinder 1 (i.e., vessel) in which granulating/coating is performed, fluidized layer forming section 2 in which the powder to be treated is fluidized, a spray nozzle 4 for coating the fluidized powder with a coating liquid (i.e., two-phase flow), a rotating disc 5 for agitating or tumbling the powder bed, and a pump 3 for feeding the coating liquid (i.e., a coating agent in a liquid form) to the spray nozzle 4. Numeral 15 denotes a spray gas passage through which a spray gas is fed.

The coating device further includes one or more lower air supplying units and one or more upper air supplying units. The lower air supplying unit fluidizes the powder bed (i.e., serves as a fluidizing device) while drying the powder bed. The upper air supplying unit is used for drying the particles of the powder near an internal pipe 13.

The lower air supplying unit includes a humidity controller 6 for controlling the humidity of air, a blower 7 for feeding air to the cylinder 1, and a tube 8 through which air is fed to the cylinder 1. The humidity controller 6 is typically a dehumidifier. The upper air supplying unit includes a humidity controller 9 for controlling the humidity of air, a blower 10 for feeding air to the cylinder 1, and a tube 11 through which air is fed to the cylinder 1. The humidity controller 9 is typically a dehumidifier.

The coating device further includes an exhaust pipe 12 through which air is exhausted from the cylinder, an internal pipe 13 for separating air (used for fluidizing the powder) from particles of the powder, and a cyclone 14 configured to feed air to the coating device while feeding air to the cyclone by rotating the disc 5 to separate the coated powder from air.

The spray nozzle is typically provided at a bottom, a side wall or an upper wall to spray the coating liquid upon the powder to be treated. The coating liquid is not necessarily sprayed toward the center of the vessel (fluidized bed), and various methods can be used for spraying a coating method in the coating device of the present invention. It is preferable that the spray nozzle is provided on a bottom or a side wall of the vessel at which the concentration of the powder to be treated is relatively high.

In particular, a side spray nozzle is effective for general fluidized bed type granulating/coating devices, and other granulating/coating devices such as MULTIPLEX and SFP from Powrex Corporation, GRANULEX and SPIRAFLOW from Freund Corporation, SPIRA COTA from Okada Seiko Co., Ltd., and AGGLOMASTER from Hosokawa Micron Corporation. For example, one of these coating devices, for which a side spray nozzle is effective, is illustrated in FIG. 1 of JP-A 09-094455 mentioned above.

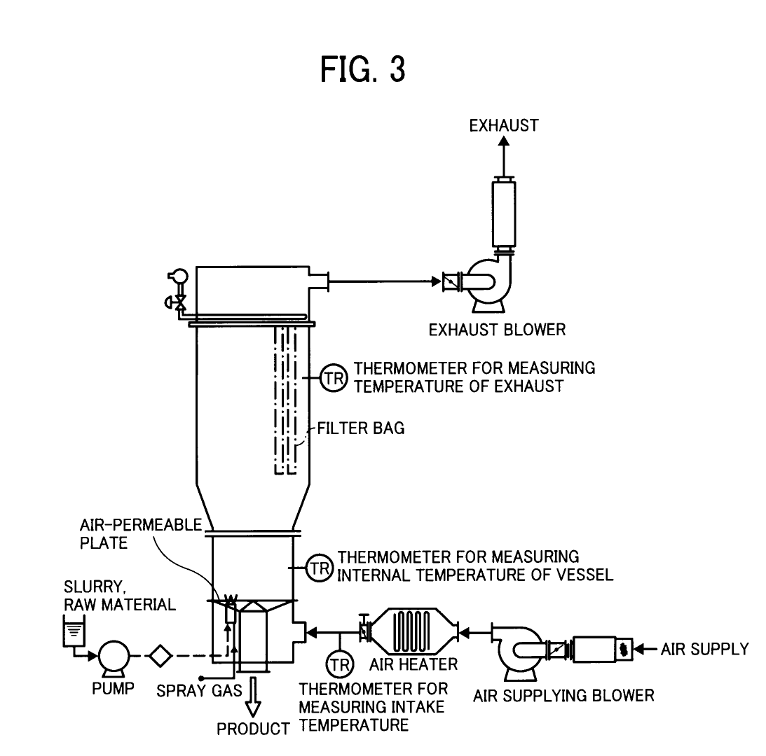

Specific examples of the coating devices for which a bottom spray nozzle is effective include general Wurster type coating devices, AGGLOMASTER AGM-SD from Hosokawa Micron Corporation, SPLUDE from Okawara Mfg. Co., Ltd., etc. For example, one of these coating devices, for which a bottom spray nozzle is effective, is illustrated in FIG. 1 of JP-A 2001-170473 mentioned above. The coating devices illustrated in FIGS. 3 and 5 of the present application are similar to the devices illustrated in FIGS. 1 and 7 of JP-A 2001-170473. In the coating device illustrated in FIG. 7 of JP-A 2001-170473, an airflow is supplied to collide against the bottom of the powder layer.

In a top spray method in which a mist of a coating liquid is sprayed in a direction opposite to the direction of the air flow for fluidizing the powder to be treated, the spray nozzle of the present invention has good nozzle clogging preventing effect. In addition, the top spray method can be used not only for the two-phase flow forming methods using a spray nozzle having venturi structure, ejector structure or ring nozzle structure, or a swirling two-phase flow forming methods but also for other fluidized bed type coating devices.

By using the granulating/coating method of the present invention, a coated carrier for use in electrophotographic developers can be efficiently produced with a high yield without causing aggregates of the coated carrier. When such a coated carrier is used for electrophotographic developers, high quality images can be produced even if used over a long period of time.

The particles of such a coated carrier include few aggregated particles, and have a uniform coated layer. Therefore, the coated carrier can be preferably used for electrophotographic developers.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Examples 1-3 and Comparative Examples 1 and 2

In order to shown that the coating method and device (granulating/coating device) of the present invention are superior to conventional coating methods and devices (granulating/coating devices) in durability, the following granulating/coating experiment was performed.

Specifically, the formula of the powder to be treated and the coating liquid are as follows.

Formula of powder to be treated

| | |
|---|---|
| Lactose | 8750 g |
| (from DMV, particles passing through a | |
| screen with 200-mesh (having openings | |
| with a diameter of about 74 μm)) | |
| Corn starch | 3750 g |
| (from Nihon Shokuhin Kako Co., Ltd.) | |

Formula of coating liquid

| | |
|---|---|
| Binder | 471.5 g |
| (HPC-L, from Nippon Soda Co., Ltd.) | |
| Lactose | 350 g |
| (from DMV, particles passing through | |
| a screen with 200-mesh) | |
| Corn starch | 150 g |
| (from Nihon Shokuhin Kako Co., Ltd.) | |
| Ion exchange water | 2424.9 g |

When the coating liquid was prepared, the components mentioned above were mixed using a mixer to dissolve the solid components in water, followed by filtering using a screen with 100-mesh. In this regard, the residue on the screen with 100-mesh (having openings with a diameter of about 149 μm) should be not greater than 1% by weight based on the total weight of the solid components.

The above-mentioned formulae of the powder and the coating liquid are based on the model formulae used for the related technical fields of the present invention (such as Society of Powder technology, Japan).

The procedure of each batch treatment is as follows. Specifically, one of the spray nozzles mentioned below was attached to the coating device mentioned below, and the coating liquid was sprayed to the powder. After all the coating liquid was consumed, the coated powder was dried. This one-batch operation was repeated until a problem (such as nozzle clogging problem) was caused. Therefore, the greater the repeated number, the better durability the coating device (spray nozzle) has. This evaluation was repeatedly made while changing the spray nozzles.

The operation conditions of the coating device are as follows.

The coating device used for Examples 1-3 and Comparative Examples 1 and 2 is a bottom spray type fluidized bed coating device, in which the powder is collided against the spray nozzle most strongly among spray coating devices. The structure of the coating device used for this experiment is illustrated in FIG. 3. In this regard, the inside diameter of the granulating portion (i.e., the vessel) is 300 mm.

At first, the powder (i.e., the mixture of lactose and cornstarch) was fed into the vessel, and the powder was fluidized using air heated to 70° C. and supplied at a flow rate of 4.5 m³/min (when measured under normal conditions).

At a time 5 minutes after the start of the fluidizing operation, the coating liquid started to be supplied to the powder at a feed rate of 67.4 g/min using a gear pump.

Air was used as the spray gas. The feed rate of air was 70 liter/min during the coating liquid was supplied, and was 15 liter/min during the coating liquid was not supplied. In this regard, the amount of air was the total amount of air for forming the two-phase flow and air for forming a mist of the two-phase flow.

The above-mentioned conditions were manually controlled, and therefore the conditions were controlled within about +10% of the targets thereof.

The other operation conditions were as follows.

### 1. Operation Conditions in Comparative Example 1

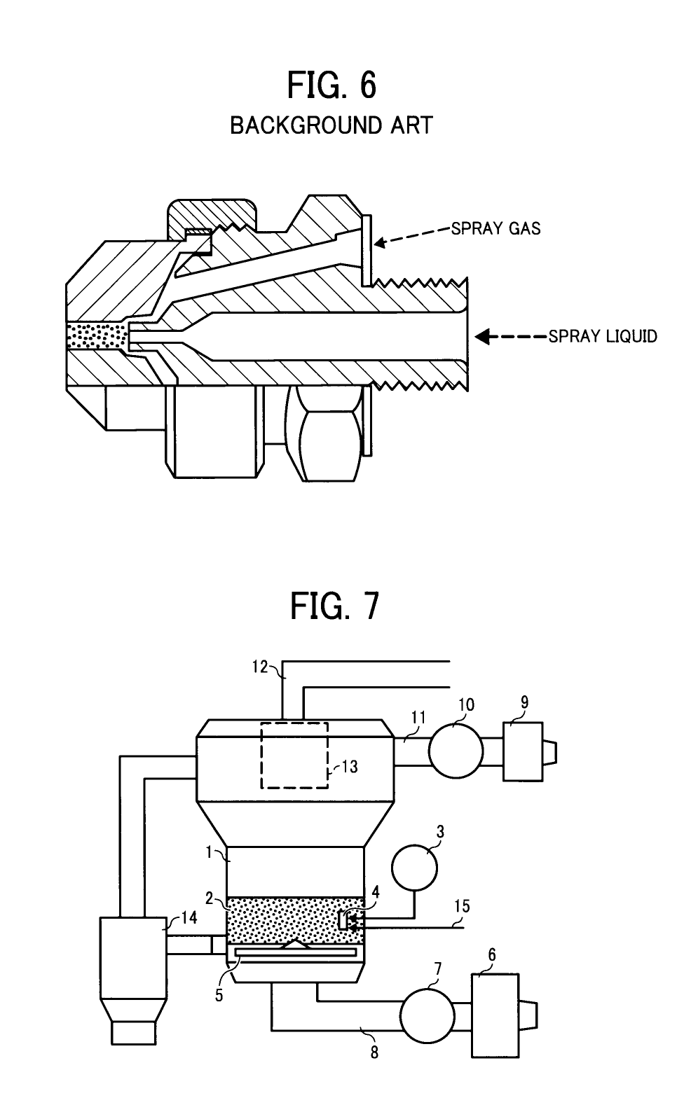

In Comparative Example 1, a typical internal mixing type spray nozzle, SPRAY SETUP SU12A from Spraying System Co. including a cap for liquid PF2050 (for forming the opening of the nozzle from which a coating liquid is discharged) and a cap for spray gas (air) PA73160 (for forming the opening of the nozzle from which a spray gas (air in this case) is discharged). The spray nozzle SPRAY SETUP SU12A has a structure as illustrated in FIG. 6.

### 2. Operation Conditions in Comparative Example 2

In Comparative Example 2, a typical internal mixing type spray nozzle, AM45S from Atomax Co., Ltd. was used. The other operation conditions were the same as those in Comparative Example 1. The details of the spray nozzle AM45S are described in JP-As 11-258857 and 05-192555. The spray nozzle AM45S is illustrated in FIG. 8, which is quoted from JP-A 05-192555.

### 3. Operation Conditions in Example 1

In Example 1, a spray nozzle, which was prepared by modifying the spray nozzle AM45S in such a manner that the liquid passage is modified such that the coating liquid is simply mixed with a spray gas to form a two-phase flow, was used. The spray nozzle has a structure as illustrated in FIG. 4.

### 4. Operation Conditions in Example 2

In Example 2, a spray nozzle having venturi structure was used. The spray nozzle was prepared by modifying the liquid passage of the spray nozzle AM45S so as to have a venturi structure. The venturi spray nozzle used has a structure as illustrated in FIG. 2. The other operation conditions were the same as those in Comparative Example 2.

### 5. Operation Conditions in Example 3

In Example 2, a spray nozzle having ejector structure was used. The spray nozzle was prepared by modifying the liquid passage of the spray nozzle AM45S so as to have an ejector structure. The ejector spray nozzle used has a structure as illustrated in FIG. 1. The other operation conditions were the same as those in Comparative Example 2.

The operation conditions are shown in Table 1.

TABLE 1

| | | | | Percentage | Percentage |
|---|---|---|---|---|---|
| | | | Method | of primary | of spray |
| | | Formation | for | spray gas | gas for |
| | | of | forming | for | forming |
| | Mixing | two-phase | two-phase | forming | two-phase |
| | method | flow | flow | mist | flow |
| Comp. | Internal | No | — | 1 (100%) | 0 (0%) |
| Ex. 1 | mixing | | | | |
| Comp. | External | No | — | 1 (100%) | 0 (0%) |
| Ex. 2 | mixing | | | | |
| Ex. 1 | Two-phase | Yes | Simple | 0.9 (90%) | 0.1 (10%) |
| | flow, | | mixing | | |
| | External | | | | |
| | mixing | | | | |
| Ex. 2 | Two-phase | Yes | Venturi | 0.9 (90%) | 0.1 (10%) |
| | flow, | | | | |
| | External | | | | |
| | mixing | | | | |
| Ex. 3 | Two-phase | Yes | Ejector | 0.9 (90%) | 0.1 (10%) |
| | flow, | | | | |
| | External | | | | |
| | mixing | | | | |

The results (i.e., the number of normally prepared batches of coated powder until a problem occurred) are shown in Table 2.

TABLE 2

| | The number of normally |
|---|---|
| | prepared batches of |
| | coated powder until |
| | a problem occurred. |
| Comp. | 2 |
| Ex. 1 | |
| Comp. | 3 |
| Ex. 2 | |
| Ex. 1 | 4 |
| Ex. 2 | 6 |
| Ex. 3 | 8 |

In addition, ion exchange water was sprayed by these coating liquid to measure the particle diameter (D50) of the droplets of sprayed water. The results are shown in Table 3.

TABLE 3

| | The particle diameter |
|---|---|
| | (D50) of droplets of |
| | sprayed water (μm) |
| Comp. | 13 |
| Ex. 1 | |
| Comp. | 16 |
| Ex. 2 | |
| Ex. 1 | 12 |
| Ex. 2 | 6 |
| Ex. 3 | 7 |

It is clear from Table 3 that the spray nozzle used in Example 1 has almost the same granulating property as those of the spray nozzles used in Comparative Examples 1 and 2, but the spray nozzles used in Examples 2 and 3 have better granulating property than the spray nozzles used in Comparative Examples 1 and 2. It is considered that the local wetting problem in that the surface of the powder is locally wetted with the coating liquid, and the nozzle wetting problem in that the tip of the nozzle is wet with the coating liquid can be avoided thereby. On the other hand, it is clear from Table 2 that the spray nozzles used in Examples 1, 2 and 3 have better durability than the spray nozzles used in Comparative Examples 1 and 2. Judging from Tables 2 and 3, although the granulating property affects the durability, such large difference in durability cannot be produced by such (slight) difference in granulating property. Namely, it is considered that the coating device (spray nozzle) of the present invention has better nozzle clogging preventing property.

### Examples 4-6 and Comparative Examples 3 and 4

The procedure for evaluation of the spray nozzle in Example 1 was repeated except that the operation conditions were changed as follows.

Instead of the bottom spray type fluidized bed coating devices used for Examples 1-3 and Comparative Examples 1 and 2, a tumbling fluidized bed type coating device having a rotating disc, in which the powder to be treated is collided against the spray nozzle as strongly as in the case using the bottom spray type fluidized bed coating device mentioned above, was used in each of Examples 4-6 and Comparative Examples 3 and 4. In this regard, the spray nozzle is provided on the side wall of the vessel so as to extend toward the center of the vessel. The tumbling fluidized bed type coating device used has a structure as illustrated in FIG. 5, wherein the inside diameter of the vessel is 300 mm.

The procedure is as follows.

At first, the powder (i.e., the mixture of lactose and cornstarch) was fed into the vessel, and the powder was fluidized using air heated to 70° C. and supplied at a flow rate of 3.8 m³/min (when measured under normal conditions). The revolution of the rotating disc was 150 rpm.

At a time 5 minutes after the start of the fluidizing operation, the coating liquid started to be supplied to the powder at a feed rate of 67.4 g/min.

Air was used as the spray gas. The feed rate of air was 70 liter/min during the coating liquid was supplied, and was 15 liter/min during the coating liquid was not supplied.

The above-mentioned conditions were manually controlled, and therefore the conditions were controlled within about +10% of the targets thereof.

The coating operation was repeated performed until a problem such as the nozzle clogging problem occurred, to determine the number of normally prepared batches of coated powder until a problem occurred. This evaluation was performed on each spray nozzle.

The other operation conditions were as follows.

### 1. Operation Conditions in Comparative Example 3

In Comparative Example 3, a typical internal mixing type spray nozzle, SPRAY SETUP SU12A from Spraying System Co. including a cap for liquid PF2050 and a cap for air PA73160. The spray nozzle SPRAY SETUP SU12A has a structure as illustrated in FIG. 6.

### 2. Operation Conditions in Comparative Example 4

In Comparative Example 4, the internal mixing type spray nozzle used in Comparative Example 2 was used. The other operation conditions were the same as those in Comparative Example 3.

### 3. Operation Conditions in Example 4

In Example 4, the spray nozzle used in Example 1 was used. The other operation conditions were the same as those in Comparative Example 3.

### 4. Operation Conditions in Example 5

In Example 5, the spray nozzle used in Example 2 was used. The other operation conditions were the same as those in Comparative Example 3.

### 5. Operation Conditions in Example 6

In Example 6, the spray nozzle used in Example 3 was used. The other operation conditions were the same as those in Comparative Example 3.

The operation conditions are shown in Table 4.

TABLE 4

| | | | | Percentage | Percentage |
|---|---|---|---|---|---|
| | | | Method | of primary | of spray |
| | | Formation | for | spray gas | gas for |
| | | of | forming | for | forming |
| | Mixing | two-phase | two-phase | forming | two-phase |
| | method | flow | flow | mist | flow |
| Comp. | Internal | No | — | 1 (100%) | 0 (0%) |
| Ex. 3 | mixing | | | | |
| Comp. | External | No | — | 1 (100%) | 0 (0%) |
| Ex. 4 | mixing | | | | |
| Ex. 4 | Two-phase | Yes | Simple | 0.9 (90%) | 0.1 (10%) |
| | flow, | | mixing | | |
| | External | | | | |
| | mixing | | | | |
| Ex. 5 | Two-phase | Yes | Venturi | 0.9 (90%) | 0.1 (10%) |
| | flow, | | | | |
| | External | | | | |
| | mixing | | | | |
| Ex. 6 | Two-phase | Yes | Ejector | 0.9 (90%) | 0.1 (10%) |
| | flow, | | | | |
| | External | | | | |
| | mixing | | | | |

The results (i.e., the number of batches of the coated powder prepared until a problem occurred) are shown in Table 5.

TABLE 5

| | The number of normally |
|---|---|
| | prepared batches of |
| | coated powder until a |
| | problem occurred. |
| Comp. | 2 |
| Ex. 3 | |
| Comp. | 3 |
| Ex. 4 | |
| Ex. 4 | 4 |
| Ex. 5 | 6 |
| Ex. 6 | 7 |

It is clear from Tables 2 and 5 that the spray nozzles used in Examples 4, 5 and 6 have better durability than the spray nozzles used in Comparative Examples 1, 2, 3 and 4. In addition, it is clear from Tables 2 and 5 that it is more preferable to use the spray nozzle having venturi or ejector structure than the spray nozzle used in Examples 1 and 4 in which the spray gas is simply mixed with the coating liquid to prepare a two-phase flow.

As a result of an experiment performed by the present inventors, it is found that by using a ring spray nozzle having a ring nozzle, the same effects can be produced.

### Examples 7-13

The procedure for evaluation of the spray nozzle in Example 6 was repeated except that the structure of the nozzle and the volume ratio of the spray gas (air) used for forming mist to the spray gas used for forming the two-phase flow were changed as follows.

In Examples 7 to 11, an ejector spray nozzle was used. The spray nozzle was prepared by modifying the liquid passage of the spray nozzle AM45S from Atomax Co., Ltd. (illustrated in FIG. 8) so as to have an ejector structure. The ejector spray nozzle used has a structure as illustrated in FIG. 1. The other operation conditions were the same as those in Comparative Example 2. In this regard, the length (L) of the passage for forming the two-phase flow is 10 times the circle-equivalent diameter (D) of the nozzle.

In Example 12, an ejector spray nozzle having the same structure as that of the spray nozzle used in Examples 7-11 except that the length (L) is 3.5 times the circle-equivalent diameter (D) of the nozzle was used.

In Example 13, an ejector spray nozzle having the same structure as that of the spray nozzle used in Examples 7-11 except that the length (L) is 4.5 times the circle-equivalent diameter (D) of the nozzle was used.

The structure of the nozzles and the volume ratio of the spray gas (air) used for forming mist to the spray gas used for forming the two-phase flow are shown in Table 6 and the evaluation results are shown in Table 7.

TABLE 6

| | | Percentage of | Percentage of |
|---|---|---|---|
| | Method for | primary spray | spray gas for |
| | forming | gas for forming | forming |
| | two-phase flow | mist | two-phase flow |
| Ex. 7 | Ejector (L = 10D) | 0.97 | 0.03 |
| Ex. 8 | ″ | 0.94 | 0.06 |
| Ex. 9 | ″ | 0.70 | 0.30 |
| Ex. 10 | ″ | 0.50 | 0.50 |
| Ex. 11 | ″ | 0.90 | 0.10 |
| Ex. 12 | Ejector (L = 3.5D) | 0.90 | 0.10 |
| Ex. 13 | Ejector (L = 4.5D) | 0.90 | 0.10 |

TABLE 7

| | The number of normally |
|---|---|
| | prepared batches of |
| | coated powder until a |
| | problem occurred. |
| Ex. 7 | 4 |
| Ex. 8 | 6 |
| Ex. 9 | 8 |
| Ex. 10 | 5 |
| Ex. 11 | 8 |
| Ex. 12 | 4 |
| Ex. 13 | 7 |

It is clear from Tables 6 and 7 that the volume ratio of the spray gas for forming a two-phase flow to the spray gas for forming mist of the two-phase flow is preferably from 5/95 to 40/60, and the length (L) of the passage is preferably not shorter than 4 times the circle-equivalent diameter (D) of the nozzle in order to prevent occurrence of problems (such as the nozzle clogging problem).

### Examples 14-17 and Comparative Examples 5 and 6

### First Preparation Examples of Carrier for Use in Electrophotographic Developer

Examples and Comparative Examples in which the coating method of the present invention applies to a carrier for use in an electrophotographic developer will be explained in detail.

The following conditions are fixed.
(1) Coating device: Rolling fluidized bed type coating device from Okada Seiko Co., Ltd. having a structure as illustrated in FIG. 7
(2) Diameter of the coating device: 50 cm
(3) Height of the coating device: 120 cm
(4) Diameter of the disc 5 (illustrated in FIG. 7): 40 cm
(5) Amount of the powder to be treated (calcined ferrite powder having an average particle diameter of 35 μm serving as core material of carrier): 10 kg
(6) Amount of air fluidizing the powder: 4.5 m³/min (air from the lower side), and 1.5 m³/min (air from the upper side)
(7) Spray nozzles: two top spray nozzles were used
(8) Amount of fed spray gas: 130 ml/min for each nozzle
(9) Amount of fed coating liquid: 32 ml/min for each nozzle
(10) Specific gravity of coating liquid: 0.97 g/cm³
(11) Formula of coating liquid

| | |
|---|---|
| Silicone resin solution | 227 parts |
| (SR2411 from Dow Corning Toray Silicone | |
| Co., Ltd., solid content of 15% by weight) | |
| γ-(2-aminoethyl)aminopropyltrimethoxysilane | 6 parts |
| Particulate alumina | 140 parts |
| (Average particle diameter of 0.3 μm, resistivity | |
| of 10¹⁴ Ω · cm) | |
| Toluene | 900 parts |
| Butylcellosolve | 900 parts |

The above-mentioned components were mixed for 10 minutes with a HOMOMIXER mixer to prepare the coating liquid.
(12) Temperature of spray gas (air): 100° C.
(13) Circumferential velocity of disc 5: 0.8 m/sec
(14) Volume ratio of air from the lower side to air from the upper side: 3:1
(15) Spray nozzles used
   The spray nozzles used in Comparative Examples 1 and 2 were used in Comparative Examples 5 and 6, respectively. The spray nozzle used in Example 1 was used in Examples 14 and 17. The spray nozzles used in Examples 2 and 3 were used in Examples 15 and 16, respectively.

After the coating treatment was completed, the coated powder was discharged from an exit provided on the bottom of the cyclone 14 while rotating the disc.

The following properties were evaluated.

### (1) Yield

The yield (Y) is defined by the following equation.

Y={P/(F+S)}×100 (%)

wherein P represents the weight of the product (i.e., the total weight of the coated carrier obtained), F represents the weight of the ferrite fed into the coating device, and S represents the total weight of the solid components included in the coating liquid.

The yield is preferably not less than 97.5%.

### (2) Amount of Powder Adhered to Coating Device

The amount (Ap) of the powder adhered to the inside of the coating device is defined by the following equation.

Ap={R/(F+S)}×100 (%)

wherein R represents the weight of the powder adhered to the inside of the coating device, F represents the weight of the ferrite fed into the coating device, and S represents the total weight of the solid components included in the coating liquid.

The amount (Ap) of the powder adhered to the inside of the coating device is preferably not greater than 2.0% by weight.

### (3) Amount of Aggregates of the Coated Carrier

The amount (Ag) of aggregates of the coated carrier is defined by the following equation.

Ag={AGG/P}×100 (%)

wherein P represents the weight of the product (i.e., the total weight of the coated carrier obtained), and AGG represents the weight of the aggregates of the coated carrier included in the product.

The amount (Ag) of aggregates of the coated carrier is preferably not greater than 2.0% by weight.

### (4) Thickness of Coated Layer

The thickness of the layer formed on the ferrite powder was measured. The thickness (T) is defined by the following equation.

T=(rt/tt)×100

wherein rt represents the real thickness of the coated layer measured, and tt represents the target thickness. Therefore, it is preferable that the thickness is closer to 100. Specifically, the thickness is preferably not less than 97.5.

### (5) Number of Normally Prepared Batches of Coated Ferrite Powder Until a Problem Occurred

The procedure for evaluation of the number of normally prepared batches of coated ferrite powder until a problem occurred is mentioned above. Namely, it is the number of the batches of the product produced without causing any problem. If 10 batches were produced without any problem, the evaluation was stopped thereat.

With respect to this evaluation item (i.e., the number of normally prepared batches), the greater the better.

The operation conditions are shown in Table 8.

TABLE 8

| | | | | Percentage | Percentage |
|---|---|---|---|---|---|
| | | | Method | of primary | of spray |
| | | Formation | for | spray gas | gas for |
| | | of | forming | for | forming |
| | Mixing | two-phase | two-phase | forming | two-phase |
| | method | flow | flow | mist | flow |
| Comp. | Internal | No | — | 1 (100%) | 0 (0%) |
| Ex. 5 | mixing | | | | |
| Comp. | External | No | — | 1 (100%) | 0 (0%) |
| Ex. 6 | mixing | | | | |
| Ex. | Two-phase | Yes | Simple | 0.9 (90%) | 0.1 (10%) |
| 14 | flow, | | mixing | | |
| | External | | | | |
| | mixing | | | | |
| Ex. | Two-phase | Yes | Venturi | 0.9 (90%) | 0.1 (10%) |
| 15 | flow, | | | | |
| | External | | | | |
| | mixing | | | | |
| Ex. | Two-phase | Yes | Ejector | 0.9 (90%) | 0.1 (10%) |
| 16 | flow, | | | | |
| | External | | | | |
| | mixing | | | | |
| Ex. | Two-phase | Yes | Simple | 0.5 (50%) | 0.5 (50%) |
| 17 | flow, | | mixing | | |
| | External | | | | |
| | mixing | | | | |

The results are shown in Table 9.

TABLE 9

| | | Amount of | | | |
|---|---|---|---|---|---|
| | | powder | Amount of | | |
| | | adhered | aggregates | | |
| | | to | of the | | Number of |
| | | coating | coated | | batches of |
| | | device | carrier | Thickness | coated |
| | | (% by | (% by | of coated | ferrite |
| | Yield (%) | weight) | weight) | layer | powder |
| Comp. | 95.4 | 3.4 | 3.4 | 96.2 | 4 |
| Ex. 5 | | | | | |
| Comp. | 97.3 | 1.1 | 1.1 | 97.4 | 5 |
| Ex. 6 | | | | | |
| Ex. | 98.4 | 0.9 | 1.1 | 98.1 | 9 |
| 14 | | | | | |
| Ex. | 98.9 | 0.4 | 0.7 | 99.6 | 10 |
| 15 | | | | | |
| Ex. | 99.1 | 0.3 | 0.8 | 99.8 | 10 |
| 16 | | | | | |
| Ex. | 98.1 | 1.0 | 1.3 | 98.0 | 8 |
| 17 | | | | | |

It is clear from Table 9 that by using the coating method and coating device of the present invention, good coated carriers for use in an electrophotographic developer, which have a coated layer having a precisely controlled thickness, can be efficiently prepared with hardly causing the nozzle clogging problem while the amounts of the powder adhered to coating device and aggregates of the coated carrier are controlled so as to be small.

The thicknesses of the coated layers formed on the core material (ferrite powder) in Examples 14-17 are closer to 100, namely closer to the target thickness. Thus, the thickness of the coated layers can be well controlled, and therefore the coating method and device of the present invention can be preferably used for forming good coated carriers for use in electrophotographic developers.

In addition, the amounts of the powder adhered to coating device and aggregates of the coated carrier are relatively small compared to those in Comparative Examples 5 and 6 where conventional spray nozzles were used. Therefore, it is clear that the coating method and device of the present invention are superior to conventional coating methods and devices. Further, the coating method and device of the present invention are superior to conventional coating methods and devices in the nozzle clogging problem preventing property because the number of normally prepared batches of coated ferrite powder is greater than those in Comparative Examples 5 and 6 where conventional spray nozzles were used.

### Second Preparation Examples of Carrier for Use in Electrophotographic Developer

The procedure for preparation and evaluation of the carrier in First Preparation Examples was repeated except that the spray coating conditions and the spray nozzle were changed.

### Example 18

In Example 18, an external mixing type spray nozzle was used. The spray nozzle was prepared by modifying the liquid passage of the spray nozzle AM45S from Atomax Co., Ltd. (illustrated in FIG. 8) such that the coating liquid and the spray gas are simply mixed to form a two-phase flow. The external mixing type spray nozzle used has a structure as illustrated in FIG. 4. In this regard, the length (L) of the passage for forming a two-phase flow (which is illustrated in FIG. 11) is 10 times the circle-equivalent diameter (D) of the nozzle.

Thus, a coated carrier was prepared.

### Example 19

In Example 19, a spray nozzle having venturi structure was used. The spray nozzle was prepared by modifying the liquid passage of the spray nozzle AM45S from Atomax Co., Ltd. (illustrated in FIG. 8) so as to have a venturi structure. The venturi spray nozzle used has a structure as illustrated in FIG. 1. In this regard, the length (L) of the liquid passage for forming a two-phase flow is 10 times the circle-equivalent diameter (D) of the nozzle.

Thus, a coated carrier was prepared.

### Example 20

In Example 20, an ejector spray nozzle was used. The spray nozzle was prepared by modifying the liquid passage of the spray nozzle AM45S from Atomax Co., Ltd. (illustrated in FIG. 8) so as to have an ejector structure. The ejector spray nozzle used has a structure as illustrated in FIG. 2. In this regard, the length (L) of the portion of the liquid passage for forming a two-phase flow is 10 times the circle-equivalent diameter (D) of the nozzle.

Thus, a coated carrier was prepared.

### Examples 21-23

The external mixing type spray nozzle used in Example 18 was used while the conditions for spraying and for forming a two-phase flow were changed as described in Table 10.

Thus, coated carriers were prepared.

### Example 24

The procedure for preparation of the coated carrier in Example 18 was repeated except that the length (L) of the passage of the spray nozzle was changed so as to be 3.5 times the circle-equivalent diameter (D) of the nozzle.

Thus, a coated carrier was prepared.

### Example 25

The procedure for preparation of the coated carrier in Example 18 was repeated except that the length (L) of the passage was changed so as to be 4.5 times the circle-equivalent diameter (D) of the nozzle.

Thus, a coated carrier was prepared.

### Example 26

The procedure for preparation of the coated carrier in Example 19 was repeated except that a torquing member having a structure as illustrated in FIG. 9 was provided in the spray nozzle to form a swirling two-phase flow.

Thus, a coated carrier was prepared.

The operation conditions are shown in Table 10.

TABLE 10

| | | | Percentage of |
|---|---|---|---|
| | | Percentage of | spray gas for |
| | Method for | primary spray | forming |
| | forming | gas for forming | two-phase |
| | two-phase flow | mist | flow |
| Ex. 18 | Simple mixing | 0.9 (90%) | 0.1 (10%) |
| Ex. 19 | Venturi | 0.9 (90%) | 0.1 (10%) |
| Ex. 20 | Ejector | 0.9 (90%) | 0.1 (10%) |
| Ex. 21 | Simple mixing | 0.5 (50%) | 0.5 (50%) |
| Ex. 22 | Simple mixing | 0.97 (90%) | 0.03 (3%) |
| Ex. 23 | Simple mixing | 0.7 (70%) | 0.3 (30%) |
| Ex. 24 | Simple mixing | 0.9 (90%) | 0.1 (10%) |
| | (L = 3.5D) | | |
| Ex. 25 | Simple mixing | 0.9 (90%) | 0.1 (10%) |
| | (L = 4.5D) | | |
| Ex. 26 | Swirling | 0.7 (70%) | 0.3 (30%) |
| | two-phase flow | | |
| | formed by | | |
| | torquing | | |
| | member | | |

The results are shown in Table 11.

TABLE 11

| | | Amount of | | | |
|---|---|---|---|---|---|
| | | powder | Amount of | | |
| | | adhered | aggregates | | |
| | | to | of the | | Number of |
| | | coating | coated | | batches of |
| | | device | carrier | Thickness | coated |
| | | (% by | (% by | of coated | ferrite |
| | Yield (%) | weight) | weight) | layer | powder |
| Ex. | 98.4 | 0.9 | 1.1 | 98.1 | 9 |
| 18 | | | | | |
| Ex. | 98.9 | 0.4 | 0.7 | 99.6 | 10 |
| 19 | | | | | |
| Ex. | 99.1 | 0.3 | 0.8 | 99.8 | 10 |
| 20 | | | | | |
| Ex. | 98.1 | 1.0 | 1.3 | 98.0 | 8 |
| 21 | | | | | |
| Ex. | 98.0 | 1.8 | 1.9 | 97.5 | 6 |
| 22 | | | | | |
| Ex. | 98.2 | 0.9 | 1.2 | 98.0 | 9 |
| 23 | | | | | |
| Ex. | 98.4 | 1.1 | 1.5 | 97.9 | 8 |
| 24 | | | | | |
| Ex. | 98.3 | 1.0 | 1.1 | 98.1 | 9 |
| 25 | | | | | |
| Ex. | 99.1 | 0.4 | 0.8 | 99.7 | 10 |
| 26 | | | | | |

It is clear from Table 11 that by using the coating method and device of the present invention, good coated carriers for use in electrophotographic developers, which have a coated layer having a precisely controlled thickness, can be efficiently prepared with hardly causing the nozzle clogging problem while the amounts of the powder adhered to coating device and aggregates of the coated carrier are controlled so as to be small.

The thicknesses of the coated layers formed on the core material (ferrite powder) in Examples 18-26 are closer to 100, namely closer to the target thickness. Thus, the thickness of the coated layers can be well controlled, and therefore the coating method and device of the present invention can be preferably used for forming good coated carriers for use in electrophotographic developers.

In addition, the amounts of the powder adhered to coating device and aggregates of the coated carrier are relatively small compared to those in Comparative Examples where conventional spray nozzles are used. Therefore, the coating method and device of the present invention are superior to conventional coating methods and devices. Further, the coating method and device of the present invention are superior to conventional coating methods and devices in the nozzle clogging problem preventing property because the number of normally prepared batches of coated ferrite powder is greater than those in Comparative Examples 5 and 6 where conventional spray nozzles are used.

As mentioned above, by using the granulating/coating method (device) of the present invention, granulating/coating treatments can be stably performed with a high yield without causing the nozzle clogging problem. Thereby, good products having uniform properties can be prepared. Because of having good processing stability and processing performance, the granulating/coating method (device) of the present invention can be preferably used for forming coated carriers for use in electrophotographic developers, which are required to have low costs and to produce high quality images.

Application of the present invention is not limited to the food industry and electrophotographic developers mentioned above. For example, the present invention can apply to granulating of chemicals such as detergents and fertilizers, which are required to have a predetermined particle diameter; coating of inorganic materials, which are used as fillers for resins; granulating and coating of drags to control the bitterness and solubility thereof; batteries in which a liquid material has to be homogeneously mixed with a solid powder; and other fields for which stable and homogeneous granulating and coating are needed.

This document claims priority and contains subject matter related to Japanese Patent Application No. 2007-154399, filed on Jun. 11, 2007, incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A method for coating particles with a coating liquid comprising:
supplying airflow to the particles in a vessel to fluidize the particles;
mixing the coating liquid with a spray gas in a passage in a two-fluid spray nozzle to form a two-phase flow; and
atomizing the two-phase flow with the spray gas to spray a mist of the coating liquid upon the fluidized particles.

2. The method according to claim 1, wherein a volume ratio of the spray gas used for forming the two-phase flow to the spray gas used for atomizing the two-phase flow is from 5/95 to 40/60.

3. The method according to claim 1, wherein a length of the passage for forming the two-phase flow is not less than 4 times a circle-equivalent diameter of an opening of the passage from which the two-phase flow is sprayed.

4. The method according to claim 1, wherein the following relationship is satisfied:
0.1≦(Yx(y/b))/(Xx(x/a)≦3,
wherein X represents a total amount (NL/min) of the spray gas used for forming the two-phase flow and atomizing the two-phase flow, x represents a specific gravity of the spray gas, Y represents an amount (ml/min) of the coating liquid used for forming the mist, y represents a specific gravity of the coating liquid, and a and b represent specific gravities of air and water, respectively.

5. The method according to claim 1, wherein the two-fluid spray nozzle has a structure selected from the group consisting of venturi structure, ejector nozzle structure and ring nozzle structure.

6. The method according to claim 1, further comprising:
swirling the two-phase flow when or after mixing the coating liquid with the spray gas.

7. The method according to claim 6, wherein the swirling step comprises:
swirling the two-phase flow by applying a torque thereto after mixing the coating liquid with the spray gas and before spraying the two-phase flow with the spray gas.

8. The method according to claim 1, wherein the airflow supplying step comprises:
supplying airflow to the particles to form a fluidized bed of the particles.

9. The method according to claim 8, wherein the airflow supplying step comprises:
supplying airflow to the particles while mixing and tumbling the fluidized bed with a rotating disc provided on a bottom of the fluidized bed.

10. The method according to claim 1, wherein the particles are particles of a carrier for use in an electrophotographic developer.

11. A coating device for coating particles with a coating liquid, comprising:
a vessel;
a fluidizing device configured to supply airflow to the particles to fluidize the particles in the vessel; and
a spray nozzle configured to mix the coating liquid with a spray gas to form a two-phase flow, and to atomize the two-phase flow with the spray gas to spray a mist of the coating liquid upon the fluidized particles.

12. The coating device according to claim 11, wherein the spray nozzle is located on a bottom of the vessel such that the mist is sprayed toward an inner portion of the vessel.

13. The coating device according to claim 11, wherein the spray nozzle is located on a side portion of the vessel such that the mist is sprayed toward an inner portion of the vessel.

14. The coating device according to claim 11, wherein the spray nozzle is located on an upper portion of the vessel such that the mist is sprayed in a direction opposite to a direction of the airflow.

15. A particulate carrier for use in a developer, comprising:
particles of a core material; and
a layer located on a surface of the particles of the core material,
wherein the particulate carrier is prepared by a method comprising:
supplying airflow to the particles of the core material in a vessel to fluidize the particles;
mixing a coating liquid for the layer with a spray gas in a passage in a two-fluid spray nozzle to form a two-phase flow; and
atomizing the two-phase flow with the spray gas to spray a mist of the coating liquid upon the fluidized particles of the core material.
